(19) United States
(12) Patent Application Publication
(10) Pub. No.: US 2014/0244448 A1
(43) Pub. Date: Aug. 28, 2014

(54) System and Method for Mapping Financial Data

(71) Applicant: BANK OF AMERICA CORPORATION, Charlotte, NC (US)

(72) Inventors: Andrew Hatton, Wilmington, DE (US); Kevin N. Green, Bead, DE (US); Joshua Luster, Wilmington, DE (US); Thomas Mucchetti, Wilmington, DE (US); Anthony Pellicane, Wilmington, DE (US)

(73) Assignee: Bank of America Corporation, Charlotte, NC (US)

(21) Appl. No.: 13/777,358

(22) Filed: Feb. 26, 2013

(51) Int. Cl. G06Q 40/00

(52) U.S. Cl. CPC G06Q 40/10
USPC 705/30

(57) ABSTRACT

Mapping financial data comprises receiving a first set of financial data from internal reporting systems. The first set of financial data is loaded into a database having high-level design segmentation. The first set of financial data is associated with a high-level segment of profitability. An input associated with the high-level segment of profitability is received in a graphical user interface. A second set of financial data is extracted from the first set of financial data according to the high-level segment of profitability received in the graphical user interface. A third set of financial data is extracted from a plurality of business units. A baseline forecast is calculated according to the second set of financial data and at least a portion of the third set of financial data. The baseline forecast is presented in the graphical user interface to determine the profitability of a new card account.

### TECHNICAL FIELD OF THE INVENTION

The present disclosure relates generally to mapping systems, and more particularly to mapping financial data.

### BACKGROUND OF THE INVENTION

Organizations seek to calculate profitability according to a variety of variables. Because organizations are more sophisticated, the number of variables to consider to properly forecast financial positions has increased. Conventional techniques do not consider all possible variables to calculate profitability, which reduces the effectiveness and efficiency of the techniques.

### SUMMARY OF THE DISCLOSURE

According to embodiments of the present disclosure, disadvantages and problems associated with mapping financial data may be reduced or eliminated.

Mapping financial data comprises receiving a first set of financial data from internal reporting systems. The first set of financial data is loaded into a database having high-level design segmentation. The first set of financial data is associated with a high-level segment of profitability. An input associated with the high-level segment of profitability is received in a graphical user interface. A second set of financial data is extracted from the first set of financial data according to the high-level segment of profitability received in the graphical user interface. A third set of financial data is extracted from a plurality of business units. A baseline forecast is calculated according to the second set of financial data and at least a portion of the third set of financial data. The baseline forecast is presented in the graphical user interface to determine the profitability of a new card account.

Certain embodiments of the present disclosure may provide one or more technical advantages. A technical advantage of one embodiment includes providing a system that accepts user inputs at a high-level segment view, which then cascades those inputs across associated low-level segments. This gives the users the ability to manage a large amount of segments and calculate their profitability without necessarily sacrificing accuracy. Moreover, due to the amount of low-level segments of profitability that an organization may use, having a tool that calculates profitability for all low-level segments conserves resources. A technical advantage of another embodiment includes providing a system with a database that includes financial data from a plurality of business units, internal and/or external to the organization. Having the ability to utilize this database for profitability forecasting allows organizations to determine a more accurate forecast. A technical advantage of another embodiment includes providing a system with the ability to store forecasts for future adjustment or reference. Having the ability to store a forecast for future adjustment or reference allows multiple users to collaborate on a forecast to ensure an accurate decision.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

For a more complete understanding of the present disclosure and its advantages, reference is made to the following descriptions, taken in conjunction with the accompanying drawings in which:

FIG. 1 illustrates a block diagram of an embodiment of a system for mapping financial data;

FIG. 2 illustrates a screenshot of a feature of a graphical user interface for selecting attributes or segments for forecasting profitability;

FIG. 3 illustrates a screenshot of a profitability forecast in a graphical user interface; and

FIG. 4 illustrates a flowchart for mapping financial data.

### DETAILED DESCRIPTION

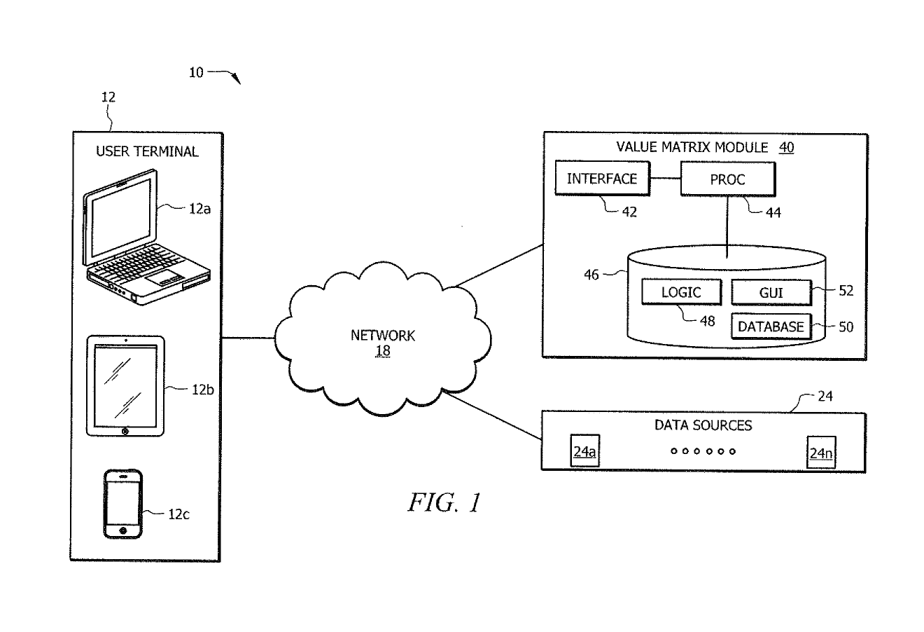

Embodiments of the present disclosure and their advantages are best understood by referring to FIGS. 1 through 4 of the drawings, like numerals being used for like and corresponding parts of the various drawings.

Organizations may calculate the profitability of a new card account according to segments of profitability. Profitability may encompass all profit and loss (P&L) components over the lifetime of an account. Generally, a low-level segment of profitability may include various low-level attributes that an organization wishes to forecast towards. A high-level segment of profitability may include various high-level attributes. Low-level attributes are, for example, a more granular attribute than their associated high-level attribute. For example, an “all behavior” high-level attribute may break down into a more granular level, listing each individual behavior as a low-level attribute. Organizations may seek to calculate profitability at the most granular level possible. Organizations may also seek to calculate profitability for aggregates of low-level attributes. However, organizations are becoming increasingly complex such that calculating profitability at the most granular level is not efficient. For example, an organization may have 300 high-level segments, which may break down into 5,000 low-level segments. Currently, there is not an efficient tool for computing profitability of a new card account for all segments. Therefore, a system and method is needed to efficiently calculate the profitability of a new card account at the most granular level. To solve this problem, an organization may calculate segment level profitability using mapping techniques, balance curve development, and P&L automation.

FIG. 1 illustrates a block diagram of an embodiment of a system for mapping financial data. System 10 includes user terminals 12 to communicate over network 18 with value matrix module 40 to facilitate mapping financial data for profitability forecasts. System 10 includes data sources 24 that communicate over network 18 with value matrix module 40 to transmit financial data for profitability forecasts. Data sources 24 store various sets of financial data from a plurality of business units or internal reporting systems. System 10 includes value matrix module 40 for facilitating the mapping process, for calculating the profitability of a new card account, and for providing a graphical user interface (GUI) 52. Value matrix module 40 receives a first set of financial data over network 18 from data sources 24, loads the first set of financial data into database 50, and associates the first set of financial data with high-level segments of profitability. Generally, the first set of financial data includes actual data from past segment performances. In some embodiments, the first set of financial data may also include data from external inputs. Using user terminals 12, a user may input, for example, a unique identifier associated with a high-level segment of profitability in GUI 52. Value matrix module 40 receives an input over network 18 from user terminals 12 and extracts a second set of financial data from the first set of financial data according to the input received. Value matrix module 40 receives a third set of financial data from a plurality of business units at the low-level segment view and loads the third set of data into database 50. Value matrix module 40 calculates a baseline forecast according to the second set of financial data and at least a portion of the third set of financial data and presents the baseline forecast in GUI 52 to determine the profitability of a new card account. Having received an input associated with a high-level segment of profitability and calculated a baseline forecast according to high-level and low-level data, an organization is able to accurately determine the profitability of a new card account in an efficient manner.

System 10 includes user terminals 12 for communicating with value matrix module 40 over network 18. For example, a user may use user terminals 12 to input a unique identifier corresponding to a high-level segment of profitability. User terminals 12 may then communicate the input to value matrix module 40 over network 18. As another example, a user may use user terminals 12 to input a customized combination of attributes associated with a low-level segment that is communicated from user terminals 12 to value matrix module 40 over network 18. User terminals 12 may be a personal computer, a tablet, a smartphone, or any other device, wireless, wireline, or otherwise, capable of receiving, processing, storing, and/or communicating information with other components of the system. User terminals 12 may also include a user interface such as a display, a touchscreen, a microphone, a keypad, or other appropriate terminal equipment useable by a user.

Network 18 represents any suitable network operable to facilitate communication between the components of system 10, such as user terminals 12, data sources 24, and value matrix module 40. Network 18 may include any interconnecting system capable of transmitting audio, video, signals, data, messages, or any combination of the preceding. Network 18 may include all or a portion of a public switched telephone network (PSTN), a public or private data network, a local area network (LAN), a metropolitan area network (MAN), a wide area network (WAN), a local, regional, or global communication or computer network such as the internet, a wireline network, an enterprise intranet, or any other suitable communication link, including combinations thereof, operable to facilitate communication between the components.

System 10 includes data sources 24 that store financial data from a plurality of business units or internal reporting systems. Data from data sources 24 is communicated to value matrix module 40 over network 18. Data from data sources 24 may be communicated to value matrix module 40 over network 18 hourly, daily, weekly, monthly, or any other period of time. In general, data sources 24 may be any collection of structured and/or unstructured data. For example, data sources 24 may be a text file, a web page, a database, a spreadsheet, a document, an inventory flat file, a data warehouse, a machine configuration file, or any other suitable source of information. In an embodiment, data sources 24 include data from a plurality of business units, which may be internal and/or external to an organization. For example, data sources 24 may include information from a marketing business unit, a risk business unit, a finance business unit, and a government entity. Utilizing data from a variety of different business perspectives allows for a more accurate profitability forecast. In certain embodiments, data sources 24 may include any suitable information generated and/or gathered by the enterprise that is representative of the profitability of a new card account. For example, data sources 24 may include operating expenses; account performance drivers, such as activation, cash/retail volume, or balance curves; interchange rate and cost per reward point; net credit losses; approval rates; strategy overlays; FICO scores; net converted rates; cost per account; economic overlays, such as GDP growth; contract and promotional pricing; cost of funds; and equity allocation and cost of capital. Data sources 24 may also include data from internal reporting systems, which may include historical data to capture past performances (e.g., Actuals).

Value matrix module 40 represents any suitable component that facilitates the creation of high-level segmentation, the reception of a first set of financial data, the association of the first set of financial data with high-level segments in database 50, the reception of an input from a user in a GUI 52, the extraction of a second set of financial data from the first set of financial data, the reception of a third set of financial data, the loading of the third set of financial data into database 50, the calculation of a baseline forecast, and/or the presentation of a baseline forecast in GUI 52. Value matrix module 40 may include a network server, any suitable remote server, a mainframe, a host computer, a workstation, a web server, a personal computer, a file server, or any other suitable device operable to communicate with user devices 12 and data sources 24. In some embodiments, value matrix module 40 may execute any suitable operating system, such as IBMs, Z Series/Operating System (Z/OS), MS-DOS, PC, DOS, MAC-OS, Windows, Unix, Open VMS, or any other appropriate operating system including future operating systems. The functions of value matrix module 40 may be performed by any suitable combination of one or more servers or other components at one or more locations. In the embodiment where value matrix module 40 is a server, the server may be a private server or the server may be a virtual or physical server. The server may include one or more servers at the same or remote locations. Also, value matrix module 40 may include any suitable component that functions as a server. In the illustrated embodiment, value matrix module 40 includes network interface 42, processor 44, and memory 46.

Network interface 42 represents any suitable device operable to receive information from network 18, transmit information through network 18, perform processing of information, communicate with other devices or any combination of the preceding. For example, network interface 42 may receive a user input over network 18 via user terminals 12. As another example, network interface 42 may receive financial data from data sources 24 over network 18. As another example, network interface 42 may communicate a profitability forecast to user terminals 12 over network 18. Network interface 42 represents any port or connection, real or virtual, including any suitable hardware and/or software including protocol conversion and data processing capabilities to communicate through a LAN, a WAN, a MAN, or other communication systems that allow value matrix module 40 to exchange information with network 18, data sources 24, or user terminals 12.

Processor 44 communicatively couples to network interface 42 and memory 46 and controls the operation and administration of value matrix module 40 by processing information received from network interface 42 and memory 46. Processor 44 includes any hardware and/or software that operates to control and process information. For example, processor 44 executes logic 48 to control the operation of value matrix module 40. Processor 44 may be a programmable logic device, a microcontroller, a microprocessor, any suitable processing device, or any suitable combination of the preceding.

Memory 46 stores, either permanently or temporarily, data, operational software or other information for processor 44. Memory 46 includes any one or a combination of volatile or nonvolatile, local or remote devices suitable for storing information. For example, memory 46 may include RAM, ROM, magnetic storage devices, optical storage devices, or any other suitable information storage device or a combination of these devices. While illustrated as including particular modules, memory 46 may include any suitable information for use in the operation of value matrix module 40. In the illustrated embodiment, memory 46 includes logic 48 for creating high-level design segmentation and loading the high-level design segmentation into database 50, receiving a first set of financial data and associating the received data with high-level segments of profitability, extracting a second set of financial data from database 50 based on a user input, receiving a third set of financial data from a plurality of business units and loading the third set of data into database 50, calculating a baseline forecast and presenting the baseline forecast in GUI 52.

Logic 48 generally refers to logic, rules, algorithms, code, tables, and/or other suitable instructions embodied in a computer readable storage medium for performing the described functions and operations of value matrix module 40. For example, logic 48 facilitates the extraction of the second set of financial data from database 50 based on an input received in GUI 52. Based on the extracted data and other received data, logic 48 facilitates the calculation of a baseline forecast. Once the baseline forecast is calculated, logic 48 facilitates the presentation of a baseline forecast in GUI 52.

In an embodiment, memory 46 includes database 50 for storing information. In general, database 50 stores information received over network 18 from data sources 24. In certain embodiments, database 50 may be a Microsoft Access® database. In other embodiments, database 50 may be a Microsoft Excel® spreadsheet. In certain embodiments, database 50 may store information related to operating expenses; account performance drivers, such as activation, cash/retail volume, or balance curves; interchange rate and cost per reward point; net credit losses; approval rates; strategy overlays; FICO scores; net converted rates; cost per account; economic overlays, such as GDP growth; contract and promotional pricing; cost of funds; and equity allocation and cost of capital. Database 50 may also store data related to an organization's internal reporting systems, such as historical data.

Memory 46 includes GUI 52, which may be delivered using an online portal, hypertext mark-up language (HTML) pages for display and data capture, or in any other suitable manner. In an embodiment, GUI 52 may allow a user of user terminals 12 to input a unique identifier corresponding to a high-level segment of profitability to forecast. In another embodiment, GUI 52 may allow a user of user terminals 12 to input a customized combination of attributes corresponding to a high-level or low-level segment of profitability. In certain embodiments, GUI 52 may allow a user of user terminals 12 to access all or a portion of the functionality associated with value matrix module 40 (as described in further detail below).

In an exemplary embodiment of operation of system 10, value matrix module 40 creates high-level design segmentation and loads the high-level design segmentation into database 50. Value matrix module 40 receives a first set of financial data from data sources 24 over network 18, which may include data from internal reporting systems. Value matrix module 40 associates the first set of financial data with high-level segments of profitability. Value matrix module 40 receives an input from user terminals 12 over network 18. The input may be associated with a high-level segment of profitability. Value matrix module 40 extracts a second set of financial data based on the input received from user terminals 12. Value matrix module 40 receives a third set of financial data from a plurality of business units and loads the third set of financial data into database 50. Value matrix module 40 calculates a baseline forecast according to the second set of financial data and at least a portion of the third set of financial data and presents the forecast in GUI 52.

A component of system 10 may include an interface, logic, memory, and/or other suitable element. An interface receives input, sends output, processes the input and/or output and/or performs other suitable operations. An interface may comprise hardware and/or software. Logic performs the operation of the component, for example, logic executes instructions to generate output from input. Logic may include hardware, software, and/or other logic. Logic may be encoded in one or more tangible media, such as a computer-readable medium or any other suitable tangible medium, and may perform operations when executed by a computer. Certain logic, such as a processor, may manage the operation of a component. Examples of a processor include one or more computers, one or more microprocessors, one or more applications, and/or other logic.

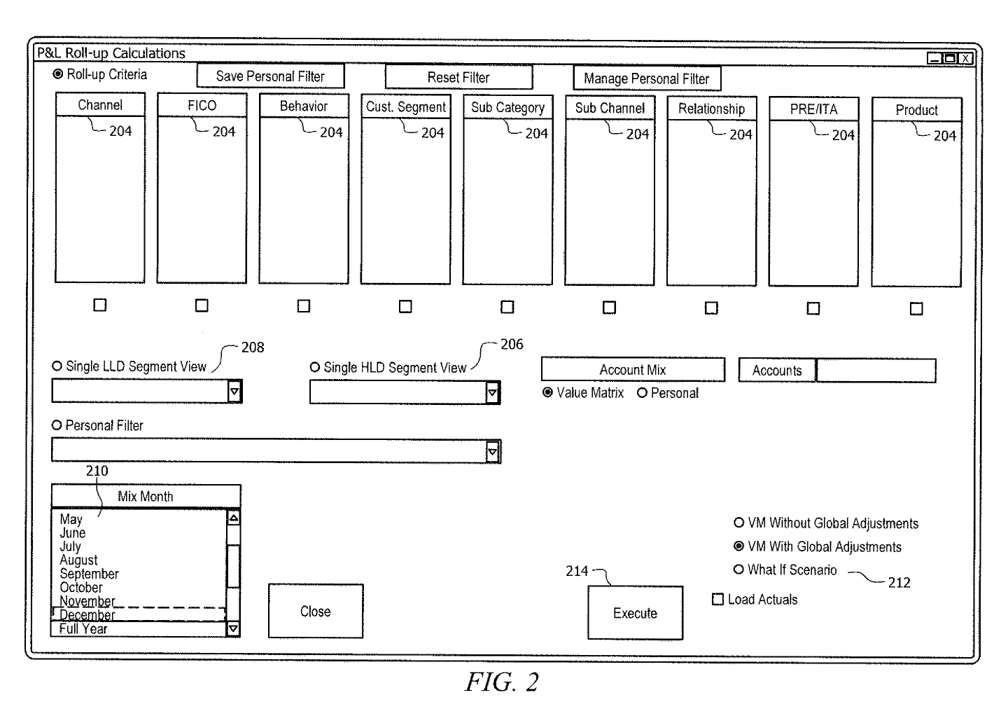

FIG. 2 illustrates a screenshot of a feature of GUI 52 for selecting attributes or segments for forecasting profitability. In some embodiments, GUI 52 may include various categories of attributes 204 that a user may select in order to develop a customized segment of profitability for a forecast. For example, a selection of an attribute 204 or combination of attributes 204 within the following high-level attributes in GUI 52 could make up a segment of profitability: channel, FICO, behavior, customer segment, preapproved (“PRE”)/invitation to apply (“ITA”), and product. In certain embodiments, a user does not have to select every attribute 204 to develop a segment of profitability. However, GUI 52 may give the user the option of selecting all relevant attributes 204. As an example of selecting attributes 204, user may use check boxes to enable categories of attributes 204 for selection and subsequently select attributes 204 within the categories for forecasting. Although various categories of high-level attributes are displayed in GUI 52, various additional categories of attributes 204 may be used in the alternative. The various categories of high-level attributes may allow for high-level segmentation within database 50.

In an embodiment, there are high-level segments of profitability and low-level segments of profitability. As noted above, a high-level segment of profitability, for example, may include a single high-level attribute or a combination of high-level attributes. A high-level segment may have high-level data and/or corresponding low-level data. For example, high-level attribute “all behavior” may include low-level data corresponding to the various low-level attributes included within the “all behavior” high-level attribute. In this manner, selection of the “all behavior” high-level attribute may result in data cascading from the high-level attribute to the low-level attributes falling within the high-level attribute. In certain embodiments, a low-level segment comprises a set of low-level attributes. For example, a low-level segment may include the following low-level attributes: direct mail marketing, customers with a FICO score less than 680, and all products. Those low-level attributes may have associated high-level data. However, some selected high-level attributes may have relevant low-level attributes that may be forecasted. For example, FICO may be broken into low-level attributes, such as 677, 678, and 679. As another example, FICO may be broken down into ranges such as 660-680 or 680-730. Those low-level attributes that form a low-level segment may have high-level data, such as data associated with all FICO scores. As another example, attribute 204 “product” may be broken into low-level attributes corresponding to various products, such as a cash rewards card, an airline rewards card, or a store rewards card. In that case, “product” may have high-level data as well associated low-level data for each product.

In certain embodiments, a user may forecast profitability of a new card account using a low-level segment of profitability. For example, a user may select a customized combination of low-level attributes that make up a single low-level segment, such as selecting direct mail under the channel attribute 204, a FICO score of 730 to 779 under the FICO attribute 204, cash only behavior under the behavior attribute 204, relationship preferred under the customer segment attribute 204, affinity under the sub-channel attribute 204, pre-approved under the pre/ITA attribute 204, and cash 123 under the product attribute 204. That combination of low-level attributes may result in the development of a single low-level segment of profitability for a new card account. The above named low-level attributes are intended as examples only. Each organization may develop its own set of relevant low-level attributes to forecast profitability of a new card account.

In certain other embodiments, a user may select a predetermined high-level segment of profitability using, for example, drop box 206. As an example, a predetermined high-level segment of profitability may have a unique identifier, such as a number and/or a name, that the user selects using drop box 206. Although GUI 52 is displayed having drop box 206, other embodiments could contain different methods of selecting a high-level segment of profitability, such as radio buttons.

In some embodiments, a user may select a predetermined low-level segment of profitability using, for example, drop box 208. As an example, a predetermined low-level segment of profitability may have a unique identifier, such as a number and/or a name, that the user selects using drop box 208. A low-level segment of profitability, for example, might include the above example of a high-level segment of profitability but at a more granular level for attributes 204. For example, the FICO attribute 204 may be selected as 730-779 as a low-level attribute. However, in certain embodiments, a user may forecast attributes 204 at a lower level, such as 731, 732, and 733. In such a case, a user could select the predetermined low-level segment that contains those low-level attributes. As another example, a user may select a low-level attribute, such as “all products.” Within that low-level attribute 204, there are multiple relevant lower-level attributes, such as an airline rewards card, a cashback rewards card, or a points rewards card. In such a case, a user may simply select the low-level attribute that the user wants to forecast for, such as airline rewards cards. As yet another example, a user may select multiple low-level segments of profitability using drop box 208. Although GUI 52 is displayed having drop box 208, other embodiments could contain different methods of selecting a low-level segment of profitability, such as radio buttons.

In certain embodiments, GUI 52 allows profitability forecasts for any month of a year. For example, GUI 52 contains a time-period selection box that may allow a user to forecast profitability for a single month or a full year. In other embodiments, GUI 52 may permit forecasting for any time period, such as a six-month time period. Other embodiments may allow forecasting in smaller time increments, such as weekly.

In certain embodiments, a user may use radio button 212 to select what calculated baseline forecast version the user desires to display. In some embodiments, the baseline forecast may contain a user's prior adjustments to the baseline forecast such that selecting radio button 212 loads the adjusted baseline forecast. In some embodiments, the adjusted baseline forecast that is loaded may include a percentage-level increase or decrease of a certain type of data, such as increasing the interchange rate. As another example, the adjusted baseline forecast may include a percentage-level increase or decrease in certain drivers, such as cash per active or retail per active As additional examples, an adjustment may be the selection of different attributes or a different time period. In some embodiments, the user may load an original baseline forecast and then input adjustments to the baseline forecast in GUI 52 (screen not displayed). Once the inputs or adjustments are received, a user may click, for example, an execute button so that logic 48 calculates or adjusts the forecasts and presents the forecasts in GUI 52.

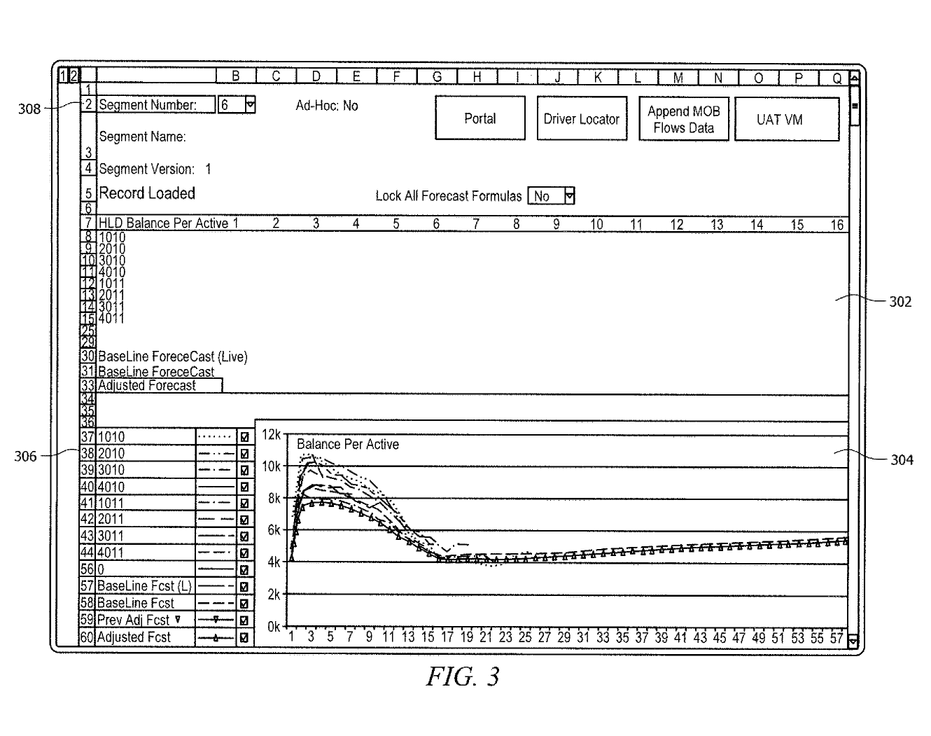

FIG. 3 illustrates a screenshot of a profitability forecast in GUI 52. In certain embodiments, GUI 52 may present a forecast in tabular format 302 and/or graphical format 304. In certain embodiments, tabular format 302 includes a profitability forecast in rows and columns of data corresponding to a high-level segment of profitability or a low-level segment of profitability depending on what the user has selected. In certain embodiments, graphical format 304 includes a profitability forecast in graphical form, such as a line graph or a bar graph. GUI 52 may include drop box 308 to allow a user to switch between high-level segments and low-level segments. For example, a user may select a different segment corresponding to a high-level or low-level segment. In some embodiments, the user may select a unique identifier corresponding to the segment, such as a letter, symbol, or number. As another example, GUI 52 may include tabs allowing a user to switch between segments.

GUI 52 may also permit a user to change the time period for which the profitability forecast is displayed. For example, a user may select check box 306 to display profitability forecasts for different quarters. Although the screenshot shows a profitability forecast for five years, other embodiments permit profitability forecasts for less than five years or more than five years. In some embodiments, a user may select or de-select check boxes 306 to alter which forecasts are displayed in tabular format 302 and/or graphical format 304. For example, a user may display a forecast for a single quarter, or display forecasts for multiple quarters.

GUI 52 may allow a user to dynamically adjust a profitability forecast. For example, a user may manually enter data into tabular format 302 or manually adjust graphical format 304 by dragging data points. In some embodiments, the adjusted forecast may be presented at the same time as all other forecasts.

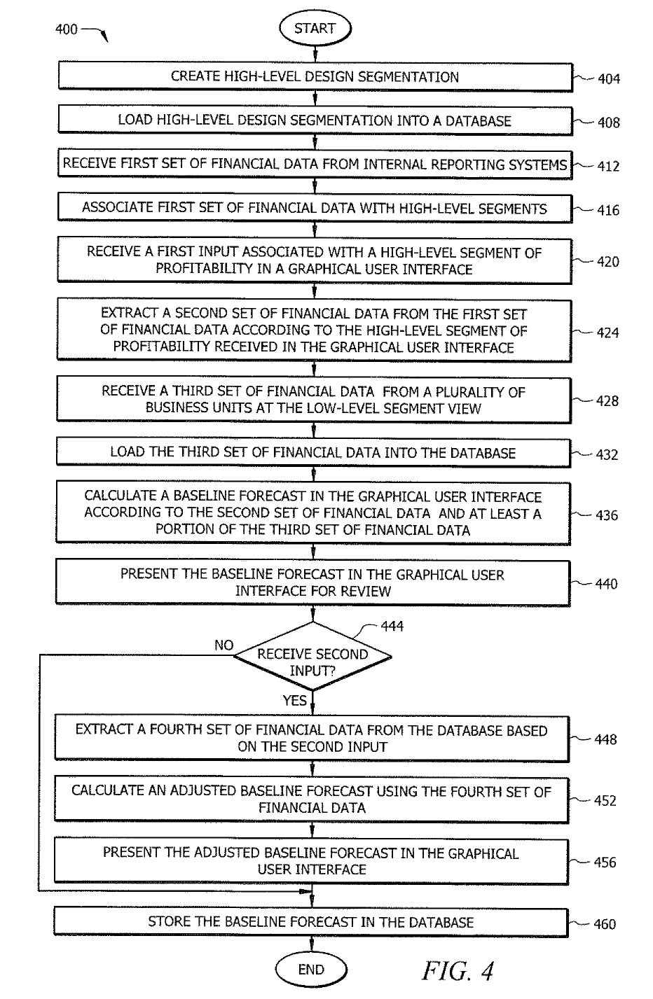

FIG. 4 illustrates a flowchart 400 for mapping financial data. At step 404, the high-level design (“HLD”) segmentation is created. As an example, a user may load a preexisting single high-level segment or multiple high-level segments. As another example, a user may create a new high-level segment or multiple high-level segments. In some embodiments, a user may elect to load the preexisting HLD segmentation with commentary such that the user may also view the details for the calculation used for the forecast. In some embodiments, the default version loaded is the most recent version, but some embodiments may allow a user to load prior versions. At step 408, the HLD segmentation is loaded into database 50. At step 412, a first set of financial data is received from data sources 24. In some embodiments, the first set of financial data received from data sources 24 is based on data from the organization's internal reporting systems to capture past performances (e.g., Actuals). For example, the first set of financial data may include historical data concerning the customer. Historical data may also include historical data concerning other customers that behave similarly to the customer for which the profitability of a new card account is being forecasted. For example, a customer may be a new customer, but has an income range similar to other customers enrolled in the card. In that situation, historical account data may include other customer's historical data in order to accurately develop a forecast for the profitability of the new customer's new card. At step 416, the first set of financial data is associated with high-level segments of profitability. For example, data from the first set of financial data may include data relevant to a particular high-level segment of profitability.

At step 420, value matrix module 40 receives a first input associated with a high-level segment of profitability in GUI 52. In general, the first input is sent from user terminals 12 to value matrix module 40 over network 18. In certain embodiments, the input may be a unique identifier corresponding to a high-level segment of profitability. In other embodiments, the input may be a customized combination of high-level and/or low-level attributes that form a high-level segment of profitability. In yet other embodiments, the input may be a unique identifier corresponding to a low-level segment of profitability or a customized combination of low-level attributes that form a low-level segment of profitability. In still yet another embodiment, the input may be a selection of multiple low-level segments of profitability. As an example, a unique identifier may be a letter, character, number, or any type of symbol. As discussed above, a high-level segment of profitability may be a combination of various high-level attributes. In some embodiments, high-level attributes may have associated high-level data that may be stored in database 50. As previously discussed, selection of low-level attributes that form a low-level segment may have low-level data that may also be stored in database 50.

At step 424, a second set of financial data is extracted from the first set of financial data according to the high-level segment of profitability received in GUI 52. For example, if an input includes various high-level attributes, such as channel, FICO, Behavior, and Product, then financial data related to those high-level attributes may be extracted, including the low-level data for any relevant low-level attribute. In that case, high-level attribute “products” may have relevant low-level attributes, such as an airlines rewards card, that has low-level data that is extracted. In addition, high-level data for “products” may also be extracted. As another example, if an input includes high-level attribute FICO, then high-level data associated with that attribute 204 may be extracted, which may also include low-level data for low-level attributes associated with the high-level attribute, such as FICO scores of 740, 741, 742, etc. In some embodiments, high-level data corresponding to high-level attributes may also be extracted, such as high-level data for the entire FICO range.

At step 428, value matrix module 40 receives a third set of financial data from a plurality of business units. In some embodiments, the third set of financial data is received at the low-level segment view. In general, value matrix module 40 receives the third set of financial data from data sources 24. Data sources 24 includes various data from a plurality of business units, which may be internal or external to an organization. In some embodiments, the third set of financial data may include financial input data and projection data. Financial input data may include financial data from various business units that may be internal or external to an organization, such as interest rates. Projection data may include data concerning various strategies or goals of an organization, such as the number of new accounts that an organization seeks to obtain. Value matrix module 40 may receive financial data hourly, daily, weekly, monthly, or at any other time period. At step 432, the third set of financial data is loaded into database 50.

At step 436, value matrix module 40 calculates a baseline forecast for the profitability of a new card account according to the second set of financial data and at least a portion of the third set of financial data. In this manner, value matrix module 40 accepts user inputs at the high-level segment view and cascades those inputs across any associated low-level segments. This gives the users the ability to manage a large amount of segments and calculate their profitability without necessarily sacrificing accuracy. In some embodiments, the baseline forecast includes a profit and loss statement for the profitability of a new card account. In general, the baseline forecast is calculated by using balance drivers and other financial data to determine the profitability of a single account over a time period, such that the more recent actual data points determine initial magnitude of the forecast curves and older vintages determine shape of the curves across the time period. In some embodiments, the baseline forecast utilizes at least a portion of the third set of financial data based upon a user input. In that example, the user input may select various drivers, such as payment rates, activation rates, or rollover rates. As another example, the user may also select various interest rates for use in the calculation. However, in other embodiments, no user input is needed and the baseline forecast utilizes the entire third set of data to calculate the baseline forecast. In embodiments, the forecasted time period may be any time period, such as five or ten years. At step 440, the baseline forecast is presented in GUI 52. In certain embodiments, the baseline forecast may be presented in tabular format 302 and/or graphical format 304.

At step 444, a second input is received in GUI 52. In certain embodiments, the second input is an adjustment to the baseline forecast. As an example, an adjustment may be an increase or decrease of a percentage related to an attribute, such as an interchange rate. As another example, an adjustment may be the selection of a different set of attributes. As yet another example, an adjustment may be manually entering data into tabular format 302 or manually adjusting graphical format 304. At step 448, a fourth set of financial data is extracted from the database based on a second input. For example, if the adjustment changes the relevant attributes, then a fourth set of financial data corresponding to the selected attributes will be extracted in the same manner as above. At step 452, an adjusted baseline forecast is calculated using the fourth set of financial data. Generally, the adjusted baseline forecast is calculated in the same manner as above. At step 456, the adjusted baseline forecast may be presented in GUI 52. In some embodiments, the adjusted baseline forecast and the original baseline forecast may be presented together for comparison. In certain embodiments, the baseline forecast and the second forecast may be presented in tabular format 302 and/or graphical format 304. At step 460, the baseline forecast and the second forecast are stored. As an example, the forecasts may be stored in database 50. In certain embodiments, tabular format 302 and/or graphical format 304 may be stored. In other embodiments, formulas corresponding to the forecasts may be stored. In yet other embodiments, the forecast history may be stored in a log. If a second input is not received in GUI 52, the method ends.

Modifications, additions, or omissions may be made to method 400 depicted in FIG. 4. The method may include more, fewer, or other steps. Additionally, steps may be performed in parallel or in any suitable order. While discussed as value matrix module 40 performing the steps, any suitable component of system 10 may perform one or more steps of the method.

Certain embodiments of the present disclosure may provide one or more technical advantages. A technical advantage of one embodiment includes providing a system that accepts user inputs at a high-level segment view, which then cascades those inputs across associated low-level segments. This gives the users the ability to manage a large amount of segments and calculate their profitability without necessarily sacrificing accuracy. Moreover, due to the amount of low-level segments of profitability that an organization may use, having a tool that calculates profitability for all low-level segments conserves resources. A technical advantage of another embodiment includes providing a system with a database that includes financial data from a plurality of business units, internal and/or external to the organization. Having the ability to utilize this database for profitability forecasting allows organizations to determine a more accurate forecast. A technical advantage of another embodiment includes providing a system with the ability to store forecasts for future adjustment or reference. Having the ability to store a forecast for future adjustment or reference allows multiple users to collaborate on a forecast to ensure an accurate decision.

Although the present disclosure has been described in several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A system for mapping financial data, comprising:
a network interface operable to receive a first set of financial data from internal reporting systems;
a processor communicatively coupled to the network interface and operable to:
load the first set of financial data into a database having high-level design segmentation;
associate the first set of financial data with a high-level segment of profitability;
the network interface further operable to receive an input associated with a high-level segment of profitability in a graphical user interface, wherein the high-level segment is a combination of high-level data according to various attributes;
the processor further operable to:
extract a second set of financial data from the first set of financial data according to the high-level segment of profitability received in the graphical user interface, wherein the second set of financial data is high-level data;
the network interface further operable to receive a third set of financial data from a plurality of business units, wherein the third set of data is low-level data;
the processor further operable to:
load the third set of financial data into the database;
calculate a baseline forecast according to the second set of financial data and at least a portion of the third set of financial data; and
present the baseline forecast in the graphical user interface to determine profitability of a new card account.

2. The system of claim 1, wherein the baseline forecast is a profit and loss statement for a low-level segment of profitability of the new card account.

3. The system of claim 1, wherein the first set of data comprises historical account data.

4. The system of claim 1, wherein the input is a unique identifier corresponding to a high-level segment of profitability.

5. The system of claim 1, wherein the input is a customized combination of attributes associated with the high-level segment.

6. The system of claim 1, wherein the network interface is further operable to receive a second input in the graphical user interface, wherein the second input is an adjustment to the baseline forecast;
the processor further operable to:
extract a fourth set of financial data from the database according to the adjustment received in the graphical user interface;
calculate an adjusted baseline forecast using the fourth set of financial data;
present the adjusted baseline forecast in the graphical user interface; and
store the adjusted baseline forecast.

7. The system of claim 1, wherein the third set of data is data from an external source.

8. A method for mapping financial data, comprising:
receiving a first set of financial data from internal reporting systems;
loading the first set of financial data into a database having high-level design segmentation;
associating the first set of financial data with a high-level segment of profitability;
receiving an input associated with the high-level segment of profitability in a graphical user interface, wherein the high-level segment is a combination of high-level data according to various attributes;
extracting, by a processor, a second set of financial data from the first set of financial data according to the high-level segment of profitability received in the graphical user interface, wherein the second set of financial data is high-level data;
receiving a third set of financial data from a plurality of business units, wherein the third set of data is low-level data;
loading the third set of financial data into the database;
calculating a baseline forecast according to the second set of financial data and at least a portion of the third set of financial data; and
presenting the baseline forecast in the graphical user interface to determine profitability of a new card account.

9. The method of claim 8, wherein the baseline forecast is a profit and loss statement for a low-level segment of profitability of the new card account.

10. The method of claim 8, wherein the first set of data comprises historical account data.

11. The method of claim 8, wherein the input is a unique identifier corresponding to a high-level segment of profitability.

12. The method of claim 8, wherein the input is a customized combination of attributes associated with the high-level segment.

13. The method of claim 8, further comprising:
receiving a second input in the graphical user interface, wherein the second input is an adjustment to the baseline forecast;
extracting, by the processor, a fourth set of financial data from the database according to the adjustment received in the graphical user interface;
calculating an adjusted baseline forecast using the fourth set of financial data;
presenting the adjusted baseline forecast in the graphical user interface; and
storing the adjusted baseline forecast.

14. The method of claim 8, further comprising:
creating a high-level design segmentation; and
loading the high-level design segmentation into the database.

15. The method of claim 8, wherein the third set of data is data from an external source.

16. Non-transitory computer readable medium comprising logic, the logic, when executed by a processor, operable to:
receive a first set of financial data from internal reporting systems;
load the first set of financial data into a database having high-level design segmentation;
associate the first set of financial data with a high-level segment of profitability
receive an input associated with the high-level segment of profitability in a graphical user interface, wherein the high-level segment is a combination of high-level data according to various attributes;
extract a second set of financial data from the first set of financial data according to the high-level segment of profitability received in the graphical user interface, wherein the second set of financial data is high-level data;
receive a third set of financial data from a plurality of business units, wherein the third set of data is low-level data;
load the third set of financial data into the database;
calculate a baseline forecast according to the second set of financial data and at least a portion of the third set of financial data; and
present the baseline forecast in the graphical user interface to determine profitability of a new card account.

17. The computer readable medium of claim 16, wherein the baseline forecast is a profit and loss statement for a low-level segment of profitability of the new card account.

18. The computer readable medium of claim 16, wherein the first set of data comprises historical account data.

19. The computer readable medium of claim 16, wherein the input is a unique identifier corresponding to a high-level segment of profitability.

20. The computer readable medium of claim 16, wherein the input is a customized combination of attributes associated with the high-level segment.

21. The computer readable medium of claim 16, wherein the logic is further operable to:
receive a second input in the graphical user interface, wherein the second input is an adjustment to the baseline forecast;
extract a fourth set of financial data from the database according to the adjustment received in the graphical user interface;
calculate an adjusted baseline forecast using the fourth set of financial data;
present the adjusted baseline forecast in the graphical user interface; and
store the adjusted baseline forecast.

22. The computer readable medium of claim 16, wherein the logic is further operable to:
create a high-level design segmentation; and
load the high-level design segmentation into the database.
